(19) United States
(12) Patent Application Publication
(10) Pub. No.: US 2008/0136578 A1
(43) Pub. Date: Jun. 12, 2008

(54) Method for Sheathing a Varsitor Block with an Electrically Insulating Sheath, as well as a Varsitor Block for a Surge Arrester

(75) Inventors: Bernd Kruska, Berlin (DE); Rolf-Gunter Rautmann, Berlin (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 11/815,929

(22) PCT Filed: Feb. 3, 2006
(86) PCT No.: PCT/EP2006/050646

§ 371 Date: Aug. 9, 2007

(30) Foreign Application Priority Data
Feb. 11, 2005 (DE) DE102005007146.5

(51) Int. Cl. H01C 7/12

(52) U.S. Cl. 338/21; 361/126

(57) ABSTRACT

A method for coating a varistor block with an electrically insulating coating and a varistor block for a surge arrester. A varistor block is formed from several varistor elements. An electrically insulating coating is disposed around the varistor elements. The electrically insulating coating rests directly on a surface of the varistor block. Unwanted gas molecules are removed from the joining area between a surface of the varistor block and the coating before or while the electrically insulating coating is being applied to the varistor block.

Method for sheathing a varistor block with an electrically insulating sheath, as well as a varistor block for a surge arrester.

The invention relates to a method for sheathing a varistor block for a surge arrester having an electrically insulating sheath, and to a varistor block which can be produced using this method.

It is known for surge arresters to be used in electrical power transmission systems. Overvoltages occur, for example, as a result of lightning strikes on overhead lines. The surge arresters are used to dissipate overvoltages when they occur. Surge arresters are equipped with varistor blocks for this purpose. These varistor blocks have a very high or a very low impedance, depending on the applied voltage. A dissipation current path can therefore be activated, depending on the voltage level of the electrical power transmission system, by appropriate design or choice of the varistor block. The overvoltage is reduced by means of the dissipation current flowing via the dissipation current path. Once a non-critical voltage level has been reached, the varistor block assumes a very high impedance again, so that the dissipation current path is virtually completely interrupted.

Metal oxide is used to form a varistor block for a surge arrester. The metal oxide is, for example, applied to a block shape, by sintering or pressing methods. By virtue of the method, the surface of the varistor block has a certain degree of roughness. In order to reduce the roughness and to provide the surface with a certain amount of mechanical strength, it is known, for example for plastic strips to be wound tightly around the varistor blocks, so that the complete varistor block is sheathed and, in the end, the electrical contact-making points which are required to connect the block in a dissipation current path remain free.

This winding process has to be carried out using very high-quality plastic since the varistor blocks are used in the medium, high and very high voltage ranges, where strong electrical fields occur which place a heavy load on the electrical insulation. The electrically insulating sheath must therefore be wound very carefully in order not to leave any free spaces on the varistor block. The amount of insulating material should be kept as small as possible, because its quality is high and it is costly.

The process of applying the electrically insulating sheath is comparatively complex, and the quality of the encasing fluctuates despite the sheath being applied very carefully.

The invention is therefore based on the object of specifying a method which allows a varistor block to be encased with an electrically insulating sheath quickly, while at the same time allowing high quality for the transition from the varistor block to the electrically insulating sheath.

According to the invention, in the case of a method of the type mentioned initially, this is achieved in that gas molecules which are located between the sheath and the surface of the varistor block are removed before and/or during the fitting of the sheath to the varistor block.

The removal of gas molecules which are located between the electrically insulating sheath and the surface of the varistor block allows the electrically insulating sheath to be laid comparatively quickly directly on the surface of the varistor block. The removal of the gas molecules very largely prevents undesirable enclosure of gases between the varistor block and the electrically insulating sheath. Since there is no longer any need to be concerned about gas enclosures while the sheath is being fitted, the insulating sheath can be fitted to the varistor block more quickly. This results in the varistor block being completed more quickly. For example, it is possible to provide for a reduced pressure to be produced between the sheath and the surface of the varistor block. The reduced pressure in the boundary area now makes it possible, for example, to easily wind an insulating strip around the varistor block. The greater pressure outside the joint presses the insulating strip onto the varistor block. A further effective manufacturing method can provide for the electrically insulating sheath to be arranged in the form of a sleeve around the varistor block. In an arrangement such as this, the gas molecules in the contact area can be removed even before the sheath is actually fitted to the varistor block. In addition to removing gas molecules, any foreign bodies such as dust must, of course, also be removed from the joint area. Electrically insulating sheaths are advantageously formed from cured, or at least partially cured, plastics.

One particularly advantageous refinement makes it possible to provide for the sheath to be fitted in an evacuated area.

Gas molecules can be removed particularly effectively from the area of the contact between the electrically insulating sheath and the varistor block by evacuating the complete area. In this case, for example, a greatly reduced pressure, also referred to as a vacuum, is produced within a pressure-resistant vessel. This ensures removal not only of gas arranged in the joint area but also of gas located around the entire arrangement. It is therefore virtually impossible for undesirable gas molecules to now subsequently flow into the contact area with the electrically insulating sheath.

A further advantageous refinement makes it possible to provide for the sheath to be deformed under the influence of thermal energy.

Particularly when using an evacuated area, it is advantageous to deform the sheath under the influence of heat and to use the shape change that this results in to form a force-fitting joint between the varistor block and the electrically insulating sheath. This has the advantage that there is no longer any need to introduce additional adhesion promoters into the joint area since the shape change results in a connection with sufficient angular stiffness between the insulating sheath and the varistor block. It is also possible to provide for an adhesion promoter such as a fusion adhesive, grease or the like to be additionally introduced into the joint itself.

It is advantageously also possible to provide for a shrink sleeve to be used, at least in places, as the sheath.

Shrink sleeves are available at low cost in widely differing sizes as goods sold by length. Since, apart from its electrical contact-making points, the varistor block is intended to be virtually completely surrounded by the electrically insulating sheath, shrink sleeves are particularly suitable for forming a gap-free surface on the varistor block. Furthermore shrink sleeves can easily be deformed by the influence of thermal energy. In the process, they develop a comparatively high force moment. This assists in making the varistor block mechanically robust. Furthermore, the force originating from the shrink sleeve can be used in order to attach further elements, such as fitting bodies to form connection points, to the varistor block and to be positioned on it. When choosing a suitable shrink sleeve, the wall thickness can in this case be chosen such that the shrink sleeve itself represents a type of cushioning layer around the varistor block. This makes it possible to protect metal oxide, which is used to form a varistor block and is relatively brittle, against mechanical damage. This results in further advantages, since the varistor blocks can be transported more easily.

A further object of the invention is to specify a varistor block which can be used for a surge arrester, with the surge arrester having a sheath composed of an electrically insulating material. The varistor block is intended to be highly mechanically robust and to be well protected against externally active mechanical forces.

According to the invention, in the case of a varistor block of the type mentioned above, this is achieved in that the sheath rests directly on a surface of the varistor block, and gas molecules which are located between the varistor block and the sheath are removed during and/or before the sheath is fitted to the varistor block.

The direct contact between the electrically insulating sheath and a surface of the varistor block protects it against mechanical damage. Forces that occur are damped by the sheath, and/or are distributed over a larger surface area. Cavities resulting from the gas molecules that have been removed from the contact area between the electric insulating sheath and the varistor block are avoided. In addition to making the varistor block mechanically robust, this results in a dielectrically stable connection between the varistor block and the electrically insulating sheath. The fitting of the electrically insulating sheath to the casing surface of the varistor block with virtually no enclosures suppresses the occurrence of partial discharges. When the varistor block is used for a relatively long time, partial discharges such as these can lead to a negative effect on the electrical characteristics of the varistor block, and may result in flashover on the electrically insulating sheath. Flashovers such as these would represent a ground fault, which is intolerable, in an electrical power transmission system.

A further advantageous requirement makes it possible to provide for the varistor block to have a plurality of varistor elements which are joined to one another and whose joints are at least partially covered by the sheath.

By way of example, a varistor block may be composed of a plurality of varistor elements. These block elements may, for example, all be composed of the same metal oxide or else may be composed of different metal oxides in order to achieve a varistor block with a specific resistant behavior. Furthermore, it is also possible for metal blocks or other electrically conductive elements to be inserted into the varistor block that has been assembled from a plurality of varistor elements. In order to produce as low a contact resistance as possible between the individual elements, they must be pressed against one another with a high force. The bracing of the varistor elements can advantageously be applied by the electrically insulating sheath. The use of the electrically insulating sheath to cover the joints prevents the individual varistor elements from moving laterally with respect to one another, thus resulting in a compact arrangement, comprising a large number of elements and the insulating sheath, once the sheath has been fitted. Furthermore, the covering of the joints means that the gaps and projections which are often present there are covered, resulting in a smooth outer surface. Particularly at the joints between the individual varistor elements, it is important to remove the undesirable gas molecules in good time, so that the insulating sheath rests closely against the surface of the varistor block.

In order to achieve a high mechanical strength for the varistor block, it is also possible to provide for end pieces which have shoulders which are covered by the sheath to be arranged at mutually opposite ends of the varistor block.

End pieces arranged at mutually opposite ends can advantageously be equipped with shoulders, which are likewise covered by the electrically insulating sheath. This is particularly advantageous when using a shrink sleeve, since a shrink sleeve may also have a shrinking effect in a plurality of dimensions. On the one hand the shrink sleeve merges closely with the surface of the varistor block, while on the other hand the shrinking effect can be used to brace a varistor block which is assembled from different varistor elements. By way of example, end fittings can be used as end pieces of the varistor block and are used to form a contact-making point for linking the varistor block in a dissipation current path. Covering the shoulders also ensures that the varistor block is sheathed on all sides, thus preventing the ingress of foreign bodies or moisture.

In this case, it is advantageously possible to provide for the sheath to be formed, at least in places, from a shrink sleeve.

The at least partial use of shrink sleeves, in particular with a shrink sleeve being shrunk completely around the varistor block, allows the electrically insulating sheath to be fitted quickly.

Exemplary embodiments of the invention will be described in more detail in the following text, and are illustrated schematically in the following drawings, in which:

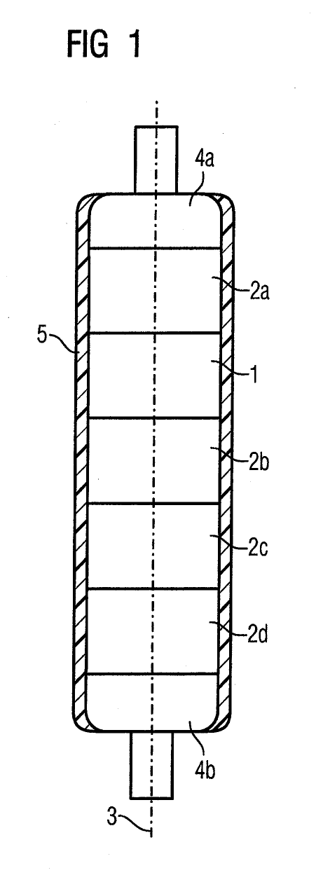

FIG. 1 shows a section through a varistor block having an electrically insulating sheath fitted directly on its surface,

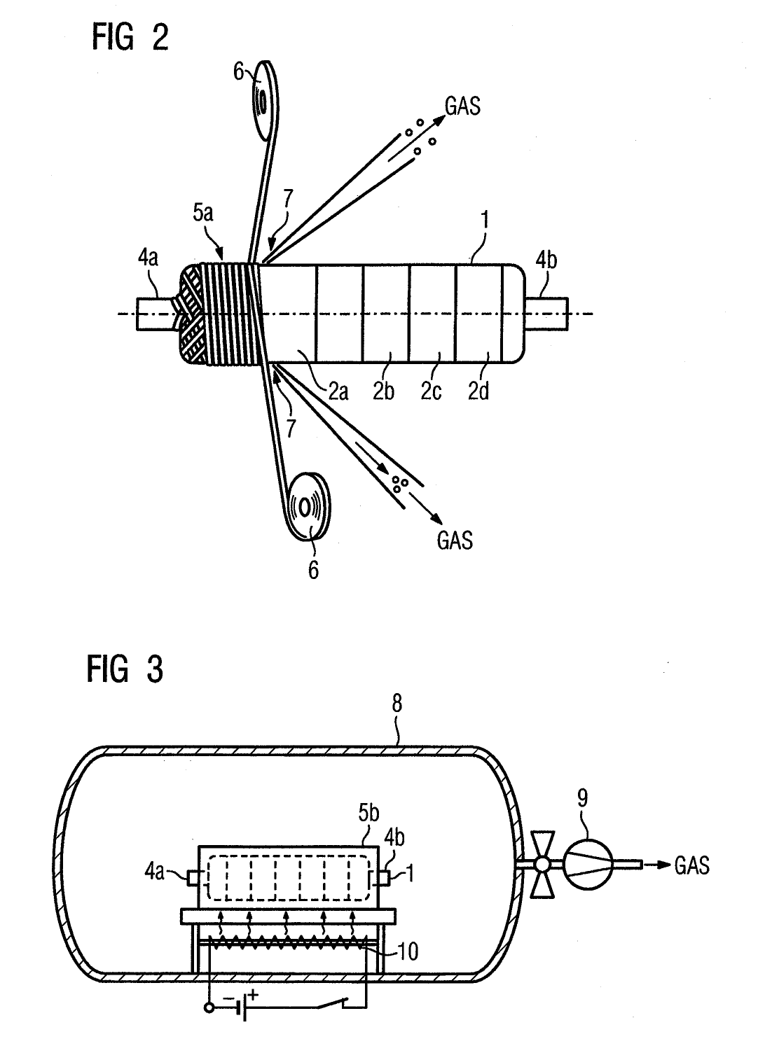

FIG. 2 shows a varistor block while an electrically insulating sheath is being fitted using a first method, and

FIG. 3 shows a varistor block while an electrically insulating sheath is being fitted using a second method.

FIG. 1 shows a section through a varistor block 1. The varistor block 1 has a plurality of varistor elements 2a, 2b, 2c, 2d. By the way of example, the varistor elements 2a, 2b, 2c, 2d, are cylindrical and are arranged with their cylinder axes coaxial with respect to a varistor block main axis 3. The end faces of the varistor elements 2a, 2b, 2c, 2d are each arranged such that they rest on one another. By way of example, sintered metal-oxide blocks can be used as varistor elements 2a, 2b, 2c, 2d. Furthermore, metallic blocks or metallic housings can also be inserted between the varistor elements 2a, 2b, 2c, 2d. These may have different dimensions, depending on the metal oxides that are available. Length compensation can then be achieved for the entire varistor block 1 by means of the metallic blocks that are inserted into the varistor block 1. In addition, a metallic block can also act as a heat sink. Furthermore, housing assemblies can also be inserted between the varistor elements 2a, 2b, 2c, 2d, into which, by way of example, monitoring devices for the temperature of the varistor block 1 are introduced. End pieces 4a, 4b are arranged at each of the mutually opposite ends of the varistor block 1. The end pieces 4a, 4b are in the form of connecting fittings, that is to say they are in the form of electrically conductive bodies which have connection points by which the varistor block 1 can be introduced into a dissipation current path. The entire varistor block 1 is surrounded by an electrically insulating sheath 5. The electrically insulating sheath 5 is formed, for example, by a multiplicity of strips being wound around it or else, as in the present example shown in FIG. 1, from a shrink sleeve. The electrically insulating sheath 5 rests directly on the casing surface of the varistor block 1, that is to say there are no gas enclosures or other bodies arranged between the joint area of the varistor block and the electrically insulating sheath 5. However, an adhesion promoter, such as an enclosure-free fusion adhesive or the like, can additionally be arranged there in order to provide good adhesion between the electrically insulating sheath 5 and the varistor block 1.

The end pieces 4a, 4b have shoulders which face away from one another in the axial direction of the varistor block main axis 3. These shoulders are formed by a conical constriction in the circumference of the end pieces 4a, 4b with respect to the varistor block main axis 3. The electrically insulating sheath clasps the shoulders of the end pieces 4a, 4b, so that the end pieces 4a, 4b and the varistor elements 2a, 2b, 2c, 2d are pressed against one another by the electrically insulating sheath 5.

The electrically insulating sheath 5 protects the varistor block 1 against external mechanical influences. Furthermore, the surface of the varistor block 1 is smoothed on the outside by the electrically insulating sheath 5, and the joints between the varistor elements 2a, 2b, 2c, 2d are covered by the electrically insulating sheath 5.

FIGS. 2 and 3 show two methods which are used to fit an electrically insulating sheath to a varistor block 1. Assemblies having the same effect are provided with the same reference symbols in the figures as in FIG. 1.

In FIG. 2, the varistor block 1 is being provided with an electrically insulating sheath 5a. The electrically insulating sheath 5a is formed from a multiplicity of turns, which are wound on the varistor block 1. For this purpose, insulating strips 6 are wound tightly onto the varistor block 1. In this variant as well, the strips 6 clasp the shoulders of the end pieces 4a, 4b and represent a close connection between the end pieces 4a, 4b and the varistor elements 2a, 2b, 2c, 2d. In order to ensure that the insulating strips rest as tightly as possible on the surface of the varistor block 1, a greatly reduced pressure is produced in the immediate area around the winding zone of the insulating strips 6. Undesirable gas molecules can be removed from the immediate area around the winding zone by skillful arrangement of a large number of strips 6, and the use of an appropriate technique. In consequence, a reduced pressure is produced in comparison to the surrounding area, so that the insulation strips 6 are pressed tightly onto the surface of the varistor block 1.

In addition to the provision of individual insulating strips 6 around the varistor block 1, this method may, however, also be utilized when using a shrink sleeve. In this case, an appropriate reduced pressure is then produced in the interior of the shrink sleeve, and the sleeve is shrunk onto the varistor block 1. In a refinement such as this as well, the individual joints between the varistor elements 2a, 2b, 2c, 2d and the end pieces 4a, 4b are completely surrounded by the electrically insulating sheath 5a.

In order to prevent the varistor element 2a, 2b, 2c, 2d, which are resting on one another, as well as the end pieces 4a, 4b from falling apart while the sheath is being fitted, they can be adhesively bonded to one another, or else can be held in an appropriate jig apparatus. In this case, it is possible to provide for the jig apparatus to be removed once the electrically insulating sheath 5a has been completely fitted, and for the bracing forces to be applied completely by the electrically insulating sheath 5a.

FIG. 3 shows a further possible way to fit an electrically insulating sheath 5b. In the present case, a varistor block 1 is arranged in the interior of an area 8 from which gas molecules have been evacuated. Undesirable gas molecules can be removed from the area 8 by means of a vacuum pump 9. In this case, it is possible to provide for the evacuation process to be carried out while the sheath is being fitted to the varistor element 1 and/or for evacuation also to be carried out before the start of the process of fitting the insulating sheath. A varistor block 1 of a known design is arranged in the interior of the evacuated area 8. The varistor block 1 is surrounded by a shrink sleeve 5b, which represents an electrically insulating sheath. Only a negligible number of gas molecules are still present in this area as a result of the evacuation of the evacuated area 8. The shrink sleeve 5b is shrunk on by supplying heat by a heating device 10. During this process, the shrink sleeve 5b can merge directly with the surface of the varistor block 1. The vacuum within the evacuated area 8 means that cavity enclosure between the shrink sleeve 5b and the block is virtually precluded. In this case, the shrink sleeve 5b has a length such that it is placed over the shoulders of the end pieces 4a, 4b and presses the end pieces 4a, 4b against one another, with the interposition of the varistor elements 2a, 2b, 2c, 2d. This results in a mechanically robust block which has a smooth outer surface. In order to hold the end pieces 4a, 4b as well as the varistor elements 2a, 2b, 2c, 2d of the varistor block 1 in position before the shrink sleeve 5b is shrunk around them, appropriate additional holding apparatus can be provided, or else the individual varistor elements 2a, 2b, 2c, 2d and the end pieces 4a, 4b can be adhesively bonded before being assembled.

In addition to using a shrink sleeve, further manufacturing methods can also be used to fit an electrically insulating sheath 5 in the evacuated area 8. For example, a winding device can also be arranged in the evacuated area 8, which winds insulating strips around the varistor block 1 and creates an electrically insulating sheath 1 in this way.

1-8. (canceled)

9. A method of sheathing a varistor block of a surge arrester, the method which comprises:
forming an electrically insulating sheath around a varistor block; and
evacuating gas molecules located between the sheath and a surface of the varistor block before and/or during a fitting of the sheath on the varistor block.

10. The method according to claim 9, which comprises fitting the sheath onto the varistor block in an evacuated area.

11. The method according to claim 9, which comprises deforming the sheath under the influence of thermal energy.

12. The method according to claim 9, wherein the sheath is formed, at least in places, of a shrink sleeve.

13. A varistor block assembly for a surge arrester, comprising a varistor block having surface and a sheath of an electrically insulating material resting directly on said surface, wherein a transition region between said varistor block and said sheath is substantially free of gas molecules, with the gas molecules having been removed from the transition region between said varistor block and said sheath during and/or before a fitting of said sheath to said varistor block.

14. The varistor block assembly according to claim 13, wherein said varistor block has a plurality of varistor elements joined to one another by way of joints, and wherein said joints are at least partially covered by said sheath.

15. The varistor block assembly according to claim 13, which comprises end pieces disposed at mutually opposite ends of said varistor block, said end pieces having shoulders covered by said sheath.

16. The varistor block assembly according to claim 13, wherein said sheath is formed, at least in places, of a shrink sleeve.
